(19) United States
(12) Patent Application Publication
(10) Pub. No.: US 2024/0290964 A1
(43) Pub. Date: Aug. 29, 2024

(54) NEGATIVE ELECTRODE ACTIVE MATERIAL AND SOLID-STATE BATTERY INCLUDING THE NEGATIVE ELECTRODE ACTIVE MATERIAL

(71) Applicant: Murata Manufacturing Co., Ltd., Nagaokakyo-shi (JP)

(72) Inventor: Ryohei TAKANO, Nagaokakyo-shi (JP)

(21) Appl. No.: 18/649,003

(22) Filed: Apr. 29, 2024

Related U.S. Application Data
(63) Continuation of application No. PCT/JP2022/039245, filed on Oct. 21, 2022.

(30) Foreign Application Priority Data
Nov. 17, 2021 (JP) 2021-187323

(51) Int. Cl. H01M 4/485; C01G 31/00; H01M 4/02; H01M 4/62; H01M 10/0525; H01M 10/0562; H01M 10/0585

(52) U.S. Cl. CPC H01M 4/485; C01G 31/00; C01G 31/006; H01M 4/62; H01M 10/0525; H01M 10/0562; H01M 10/0585; C01P 2002/54; C01P 2006/40; H01M 2004/027; H01M 2300/0071

(57) ABSTRACT

A negative electrode active material having a β-LVO-type crystal structure, in which a part of the V element of the β-LVO-type crystal structure is substituted with one or more elements capable of having a tetracoordinate structure, and preferably, the one or more elements capable of having the tetracoordinate structure are one or more elements selected from Zn, Al, Ga, Si, Ge, P, and Ti.

### CROSS REFERENCE TO RELATED APPLICATIONS

The present application is a continuation of International application No. PCT/JP2022/039245, filed Oct. 21, 2022, which claims priority to Japanese Patent Application No. 2021-187323, filed Nov. 17, 2021, the entire contents of each of which are incorporated herein by reference.

### TECHNICAL FIELD

The present disclosure relates to a negative electrode active material and a solid-state battery containing the negative electrode active material.

### BACKGROUND ART

In recent years, the demand for batteries has been greatly expanded as power supplies for portable electronic devices such as mobile phones and portable personal computers. In batteries for use in such applications, electrolytes (electrolytic solutions) such as an organic solvent have been conventionally used as media for moving ions.

However, the battery having the above configuration has a risk of leaking of the electrolytic solution, and there is also a problem that an organic solvent or the like used for the electrolytic solution is a combustible substance. Thus, it has been proposed to use a solid electrolyte instead of the electrolytic solution. In addition, development of a solid-state secondary battery (so-called “solid-state battery”) in which a solid electrolyte is used as an electrolyte and other constituent elements are also composed of a solid has been advanced.

As a negative electrode active material for a solid-state battery, a technique using a negative electrode active material having an unsubstituted β_{II}-Li₃VO₄ (LVO) type crystal structure or γ-Li₃VO₄ (LVO) type crystal structure including only Li, V, and O is known (Patent Document 1).

Patent Document 1: WO 2019/044902 A

### SUMMARY OF THE DISCLOSURE

The inventor of the present disclosure has noticed that there is a problem to be overcome in the conventional technique as described above, and has found a need to take measures therefor. Specifically, the inventor of the present disclosure has found that there is the following new problem.

In the solid-state battery using the unsubstituted β_{II}-Li₃VO₄ (LVO) type crystal structure as the negative electrode active material, although the initial reversible capacitance is high, in the solid-state battery using the solid electrolyte having the garnet type crystal structure, interface resistance between the negative electrode active material and the solid electrolyte is relatively high. On the other hand, in the solid-state battery using the γ-γ-Li₃VO₄ (LVO) type crystal structure as the negative electrode active material, the initial reversible capacitance is high; however, a capacity retention rate is relatively low when a charge rate is increased.

The present disclosure has been devised in view of such problems. That is, an object of the present disclosure is to provide a solid-state battery having a sufficiently high capacity retention rate when a charge rate is increased, and having a more sufficiently small interface resistance between a negative electrode active material and a solid electrolyte having a garnet-type crystal structure.

The present disclosure relates to a negative electrode active material having a β-LVO-type crystal structure, in which a part of the V element of the β-LVO-type crystal structure is substituted with one or more kinds of elements capable of having a tetracoordinate structure.

The present disclosure also relates to a solid-state battery including a negative electrode layer, a positive electrode layer, and a solid electrolyte layer disposed between the negative electrode layer and the positive electrode layer, in which the negative electrode layer contains the negative electrode active material.

The solid-state battery containing the negative electrode active material of the present disclosure has a sufficiently high capacity retention rate when the charge rate is increased, and has a more sufficiently small interface resistance between the negative electrode active material and the solid electrolyte having the garnet-type crystal structure.

### BRIEF EXPLANATION OF THE DRAWINGS

FIG. 1 is a schematic graph for explaining a method of evaluating an interface resistance characteristic, and illustrates a graph showing a relationship between an actual component (Za) and an imaginary component (Zb) of impedance.

FIG. 2 illustrates a charging and discharging curve of a solid-state battery prepared in Comparative Example 2.

### DETAILED DESCRIPTION OF THE PREFERRED EMBODIMENTS

### [Solid-State Battery]

The present disclosure provides a solid-state battery. The term “solid state battery” used in the present specification refers, in a broad sense, to a battery in which an electrolyte layer as a constituent element thereof is solid, and in a narrow sense, to an “all-solid state battery” whose constituent elements (in particular, all constituent elements) are solids. The “solid-state battery” in the present specification encompasses a so-called “secondary battery” that can be repeatedly charged and discharged and a “primary battery” that can only be discharged. The “solid-state battery” is preferably a “secondary battery”. The “secondary battery” is not excessively limited by the name, and may include, for example, a “power storage device” and the like.

The solid-state battery of the present disclosure includes a positive electrode layer, a negative electrode layer, and a solid electrolyte layer, and usually has a stacked structure formed by stacking the positive electrode layer and the negative electrode layer with the solid electrolyte layer interposed therebetween. Each of the positive electrode layer and the negative electrode layer may be stacked in two or more layers as long as a solid electrolyte layer is provided therebetween. The solid electrolyte layer in contact with the positive electrode layer and the negative electrode layer is sandwiched therebetween. The positive electrode layer and the solid electrolyte layer may be integrally fired, and/or the negative electrode layer and the solid electrolyte layer may be integrally fired. The term “integrally fired” means that two or more members (particularly layers) adjacent to or in contact with each other are collectively fired. Both of the two or more members (particularly, layers) may be fired bodies, and are preferably fired integrally. The solid-state battery of the present disclosure may be referred to as a “fired solid-state battery” or a “co-fired solid-state battery” in the sense that the positive electrode layer and the solid electrolyte layer are integrally fired and/or the negative electrode layer and the solid electrolyte layer are integrally fired.

### (Negative Electrode Layer)

The negative electrode layer contains a negative electrode active material and may further contain a solid electrolyte. In the negative electrode layer, both the negative electrode active material and the solid electrolyte may have the form of a fired body. For example, when the negative electrode layer contains the negative electrode active material and the solid electrolyte, the form of the fired body may be achieved in which while negative electrode active material particles are bonded to each other by the solid electrolyte, the negative electrode active material particles are bonded to each other by firing, and the negative electrode active material particles and the solid electrolyte are bonded to each other by firing.

While the negative electrode active material has a β-LVO-type structure, a part of the V element of the β-LVO-type crystal structure is substituted with one or more kinds of elements capable of having a tetracoordinate structure. The negative electrode active material having the β-LVO-type structure means that the negative electrode active material (particularly, particles thereof) has the β-LVO-type crystal structure. When the negative electrode layer contains the negative electrode active material having the β-LVO-type structure, a capacity retention rate when a charge rate is increased is improved. In addition, in a case where at least one of the negative electrode layer and the solid electrolyte layer contains a solid electrolyte having a garnet-type crystal structure, when the negative electrode layer does not contain the negative electrode active material having the β-LVO-type structure (for example, when the negative electrode layer contains only a negative electrode active material having a γ-Li₃VO₄ (LVO) type crystal structure), the capacity retention rate decreases when the charge rate is increased.

Capacity retention rate characteristic is a characteristic related to the capacity retention rate when the charge rate is increased, and is a characteristic related to a retention rate ((C₁/C_{0.1})×100(%)) of the charge capacity (C₁) when charging is performed at 1 C with respect to the charge capacity (C_{0.1}) when charging is performed at 0.1 C. The higher the capacity retention rate characteristic is, the more preferable it is. When charging is performed at a high rate, the charge capacity at the same voltage decreases as compared with charging at a low rate.

An interface resistance characteristic is a characteristic related to interface resistance between the negative electrode active material and the solid electrolyte, and the interface resistance characteristic is preferably as small as possible.

Specific examples of the β-LVO-type crystal structure of the negative electrode active material include a β_{II}-Li₃VO₄-type crystal structure. Among them, from the viewpoint of further improving the capacity retention rate characteristic and the interface resistance characteristic, the negative electrode active material preferably has a β_{II}-Li₃VO₄ type structure. At least a main component contained in the negative electrode active material may have the β-LVO-type crystal structure.

The negative electrode active material having a β_{II}-Li₃VO₄-type structure means that the negative electrode active material (in particular, particles thereof) has a β_{II}-Li₃VO₄-type crystal structure, and in a broad sense, it means that the negative electrode active material has a crystal structure that may be recognized as the β_{II}-Li₃VO₄-type crystal structure by a person skilled in the art of solid-state batteries. In a narrow sense, the negative electrode active material having the β_{II}-Li₃VO₄-type structure means that the negative electrode active material (in particular, particles thereof) exhibits one or more main peaks corresponding to Miller indices unique to a so-called β_{II}-Li₃VO₄-type crystal structure at a predetermined incident angle in X-ray diffraction. Examples of the negative electrode active material that has the β_{II}-Li₃VO₄-type structure include ICDD Card No. 01-073-6058.

The negative electrode active material contains one or more kinds of elements capable of having a tetracoordinate structure. The element capable of having the tetracoordinate structure is an element that can be substituted with the V element having the tetracoordinate structure in the β-LVO-type crystal structure. Therefore, in the present disclosure, while the negative electrode active material has a β-LVO-type crystal structure, a part of the V element of the β-LVO-type crystal structure is substituted with one or more kinds of elements capable of having the tetracoordinate structure. When the negative electrode active material contains one or more kinds of elements capable of having the tetracoordinate structure, the capacity retention rate characteristic is improved. In addition, when at least one of the negative electrode layer and the solid electrolyte layer contains the solid electrolyte having the garnet-type crystal structure, the interface resistance characteristic between the solid electrolyte and the negative electrode active material is improved. Even if the negative electrode layer contains the negative electrode active material having the β-LVO-type structure, when the negative electrode active material does not contain the element capable of having the tetracoordinate structure, the interface resistance characteristic between the solid electrolyte and the negative electrode active material is deteriorated.

Examples of the element capable of having the tetracoordinate structure include Zn, Al, Ga, Si, Ge, P, Ti, S, and Cr. The negative electrode active material usually contains one or more elements selected from the group consisting of the above elements as the element capable of having the tetracoordinate structure. From the viewpoint of further improving the capacity retention rate characteristic and the interface resistance characteristic, the negative electrode active material preferably contains one element selected from the group consisting of the above elements alone as the element capable of having the tetracoordinate structure.

From the viewpoint of further improving the capacity retention rate characteristic and the interface resistance characteristic, the negative electrode active material preferably contains one or more elements selected from the group consisting of Si, Ge, P, and Ti, more preferably contains one element selected from the group alone, and still more preferably contains one element selected from the group consisting of Si, Ge, and Ti alone as the element capable of having the tetracoordinate structure.

In the present disclosure, while the negative electrode active material has the β-LVO-type crystal structure as described above, a part of the V element of the β-LVO-type crystal structure is substituted with one or more elements capable of having the tetracoordinate structure. From the viewpoint of further improving the capacity retention rate characteristic and the interface resistance characteristic, it is preferable that when Z is defined as the one or more elements capable of having the tetracoordinate structure and r is defined as r=substance amount of Z/(substance amount of V element+substance amount of Z), 0<r≤0.20 is satisfied. In particular, it is preferable to satisfy a relationship of 0.005≤r≤0.200. When Z contains two or more kinds of elements, r is a number based on the total number thereof. The substance amount of the element V and the substance amount of Z can be calculated by determining the later-described general formula (1) as average chemical composition of the negative electrode active material. The above r determined from the amounts of substance of V and Z contained in the negative electrode active material and y in the general formula (1) representing the average chemical composition of the negative electrode active material described in detail below correspond to each other, and the value of r may be used as y in the general formula (1).

From the viewpoint of further improving the capacity retention rate characteristic and the interface resistance characteristic, the negative electrode active material preferably has average chemical composition represented by the general formula (1):

$$( {Li}_{[ 3 - ax + ( 5 - b ) y ]} {A}_{x} ) ( {V}_{1 - y} {Z}_{y} ) {O}_{4 - b} . \qquad ( 1 )$$

In Formula (1), A is one or more elements selected from the group consisting of Na (sodium), K (potassium), Mg (magnesium), Ca (calcium), Al (aluminum), Ga (gallium), Zn (zinc), Fe (iron), Cr (chromium), and Co (cobalt). From the viewpoint of further improving the capacity retention rate characteristic and the interface resistance characteristic, A is one or more kinds of elements selected from the group consisting of Mg, Al, Ga, and Zn.

Z is one or more kinds of elements capable of having the tetracoordinate structure described above. From the viewpoint of further improving the capacity retention rate characteristic and the interface resistance characteristic, Z is preferably one or more kinds of elements selected from the group consisting of Zn, Al, Ga, Si, Ge, P, Ti, S, and Cr, and more preferably one or more kinds of elements selected from the group consisting of Si, Ge, P, and Ti. From the viewpoint of further improving the capacity retention rate characteristic and the interface resistance characteristic, Z is more preferably a single element selected from each group described above.

x satisfies a relationship of 0≤x≤1.00. From the viewpoint of further improving the capacity retention rate characteristic and the interface resistance characteristic, x preferably satisfies a relationship of 0≤x≤0.20, and is more preferably 0. When A contains two or more kinds of elements, x is a number based on the total number thereof.

When V and the element capable of having the tetracoordinate structure described above are Z, y is defined as y=Z/(substance amount of V+substance amount of Z). A relationship of 0<y≤0.200 is satisfied, and particularly a relationship of 0.005≤y≤0.200 is satisfied. When Z contains two or more kinds of elements, y is a number based on the total number of y for each element. For example, a value corresponding to y related to an element Z1 capable of having the tetracoordinate structure is represented as y_{Z1}. In addition, for example, a value corresponding to y related to an element Z2 capable of having the tetracoordinate structure is represented as y_{Z2}. For example, when Z includes only Z1 and Z2, the sum of y_{Z1} and y_{Z2} may satisfy the above range of y. Specifically, the sum of y_{Z1} and y_{Z2} calculated as y_{Z1}=substance amount of Z1/{substance amount of V+(substance amount of Z1+substance amount of Z2)} and y_{Z2}=substance amount of Z2/{substance amount of V+(substance amount of Z1+substance amount of Z2)} may satisfy the above range of y. y mutually corresponds to r derived based on the substance amounts of V and Z contained in the negative electrode active material as defined above. Specifically, y in the general formula (1) may be used as the value of r obtained based on the substance amounts of V and Z contained in the negative electrode active material.

δ represents an oxygen deficiency amount and may be 0. δ may usually satisfy 0≤δ≤0.5. The oxygen deficiency amount δ cannot be quantitatively analyzed with the latest device, and thus may be considered to be 0.

a is an average valence of A. The average valence of A is, for example, a value represented by (n1× a+n2× b+n3× c)/(n1+n2+n3) when A is recognized as n1 of elements X having a valence a+, n2 of elements Y having a valence b+, and n3 of elements Z having a valence c+.

b is an average valence of Z. The average valence of Z is, for example, the same value as the average valence of A described above when Z is recognized as n1 of elements X having a valence a+, n2 of elements Y having a valence b+, and n3 of elements Z having a valence c+.

In the formula (1), a particularly preferred value of y may be determined depending on Z. When y satisfies the following range, a β-LVO structure is easily obtained, which is preferable. However, the composition range is not necessarily limited to the following composition range, and the effect of the present disclosure can be obtained by including Z in the β-LVO structure.

For example, when Z contains Si (particularly when Z is Si alone), y satisfies a relationship of 0<y≤0.050, and from the viewpoint of further improving the capacity retention rate characteristic and the interface resistance characteristic, y preferably satisfies a relationship of 0.005≤y≤0.050, more preferably 0.005≤y≤0.045, still more preferably 0.015≤y≤0.045, and particularly preferably 0.025≤y≤0.045. From the viewpoint of further improving the capacity retention rate characteristic and the interface resistance characteristic, the range of y when Z contains Si can be yₛᵢ which is a value corresponding to y related to Si.

For example, when Z contains Ge (particularly when Z is Ge alone), y satisfies a relationship of 0<y≤0.100, and from the viewpoint of further improving the capacity retention rate characteristic and the interface resistance characteristic, y preferably satisfies a relationship of 0.005≤y≤0.100, more preferably 0.015≤y≤0.100, still more preferably 0.030≤y≤0.100, and particularly preferably 0.060≤y≤0.100. From the viewpoint of further improving the capacity retention rate characteristic and the interface resistance characteristic, the range of y when Z contains Ge can be y_{Ge} which is a value corresponding to y related to Ge.

For example, when Z contains Ti (particularly when Z is Ti alone), y satisfies a relationship of 0<y≤0.150, and from the viewpoint of further improving the capacity retention rate characteristic and the interface resistance characteristic, y preferably satisfies a relationship of 0.005≤y≤0.130, more preferably 0.010≤y≤0.120, still more preferably 0.030≤y≤0.110, and particularly preferably 0.060≤y≤0.110. From the viewpoint of further improving the capacity retention rate characteristic and the interface resistance characteristic, the range of y when Z contains Ti can be y_{Ti} which is a value corresponding to y related to Ti.

For example, when Z contains P (particularly when Z includes only P and Si), y satisfies a relationship of 0<y≤0.080, and from the viewpoint of further improving the capacity retention rate characteristic and the interface resistance characteristic, y preferably satisfies a relationship of 0.010≤y≤0.060, more preferably 0.020≤y≤0.050, still more preferably 0.030≤y≤0.050, and particularly preferably 0.035≤y≤0.045. In particular, when Z contains only P and an element other than P (particularly Si), the above y is a number based on the total number of y_{P} (that is, y based only on P) corresponding to y related to P and y_{Z3} corresponding to y related to an element Z3 other than P. yₚ satisfies a relationship of 0≤yₚ≤0.100, and from the viewpoint of further improving the capacity retention rate characteristic and the interface resistance characteristic, yₚ preferably satisfies a relationship of 0.005≤yₚ≤ 0.070, more preferably 0.005≤yₚ≤0.050, and still more preferably 0.010≤yₚ≤ 0.040. Specifically, yₚ calculated as yₚ=substance amount of P/{substance amount of V+(substance amount of P+substance amount of element Z3 other than P)} may satisfy the above range of y_{P}. y_{Z3} satisfies a relationship of 0<y_{Z3}≤0.100, and from the viewpoint of further improving the capacity retention rate characteristic and the interface resistance characteristic, y_{Z3} preferably satisfies a relationship of 0.005≤y_{Z3}≤ 0.070, more preferably 0.005≤y_{Z3}≤ 0.050, and still more preferably 0.010≤y_{Z3}≤ 0.040. Specifically, y_{Z3} calculated as y_{Z3}=substance amount of element Z3 other than P/{substance amount of V+(substance amount of P+substance amount of element Z3 other than P)} may satisfy the range of y_{Z3} described above.

Specific examples of the β-LVO-type crystal structure of the negative electrode active material include Li_{3.01} (V_{0.99}Si_{0.01})O₄, Li_{3.02} (V_{0.98}Si_{0.02})O₄, Li_{3.04} (V_{0.96}Si_{0.04})O₄, Li_{3.01} (V_{0.98}Ge_{0.02})O₄, Li_{3.02}(V_{0.95}Ge_{0.05})O₄, Li_{3.04}(V_{0.91}Ge_{0.09})O₄, Li_{3.01} (V_{0.90}Ti_{0.02})O₄, Li_{3.02} (V_{0.96}Ti_{0.04})O₄, Li_{3.10} (V_{0.90}Ti_{0.10})O₄, and Li_{3.02} (V_{0.96} Si_{0.02}P_{0.02})O₄).

The chemical composition of the negative electrode active material may be average chemical composition. The average chemical composition of the negative electrode active material means an average value of the chemical compositions of the negative electrode active material in the thickness direction of the negative electrode layer. The average chemical composition of the negative electrode active material may be analyzed and measured by breaking the solid-state battery and performing composition analysis by EDX or WDX (wavelength dispersive X-ray spectroscopy) using SEM-EDX (energy dispersive X-ray spectroscopy) or WDX in a field of view in which the whole negative electrode layer fits in the thickness direction.

In the negative electrode layer, the average chemical composition of the negative electrode active material and the average chemical composition of the solid electrolyte described later can be automatically distinguished and then measured depending on the compositions thereof in the composition analysis mentioned above.

The negative electrode active material can be produced, for example, by the following method. First, a raw material compound containing a predetermined metal atom is weighed so as to have a predetermined chemical composition, and water is added and mixed to obtain a slurry. The slurry is dried, calcined at 700° C. to 1000° C. for 4 hours to 6 hours, and pulverized to obtain a negative electrode active material.

The average particle diameter of the negative electrode active material is not particularly limited, may be, for example, 0.01 μm to 20 μm, and is preferably 0.1 μm to 5 μm.

As the average particle diameter of the negative electrode active material, for example, 10 to 100 particles are randomly selected from an SEM image, and their particle diameters are simply averaged to determine the average particle diameter (arithmetic average).

The particle size is the diameter of a spherical particle when the particle is assumed to be a perfect sphere. For such a particle diameter, for example, a section of the solid-state battery is cut out, a sectional SEM image is photographed using an SEM, the sectional area S of the particle is calculated using image analysis software (for example, “Azo-kun” (manufactured by Asahi Kasei Engineering Corporation)), and then the particle diameter R may be determined by the following formula:

$$R = 2 \times {( S / π )}^{1 / 2}$$

It is to be noted that the average particle size of the negative electrode active material in the negative electrode layer can be automatically measured by specifying the negative electrode active material depending on the composition, at the time of measuring the average chemical composition mentioned above. The particle size of the negative electrode active material can be easily determined by subjecting the negative electrode active material to a thermal etching treatment after polishing, and hence the negative electrode active material may be subjected to the thermal etching treatment before the measurement of the average particle size. Specifically, the average particle size of the negative electrode active material may be an average particle size of the negative electrode active material having been subjected to the heat treatment at 700° C. for 1 hour after polishing.

The volume ratio of the negative electrode active material in the negative electrode layer is not particularly limited, but is preferably 20% to 80%, more preferably 30% to 75%, and still more preferably 30% to 60% from the viewpoint of further improving the capacity retention rate characteristic and the interface resistance characteristic.

The volume percentage of the negative electrode active material in the negative electrode layer can be measured from an SEM image after FIB sectional processing. Particularly, the cross section of the negative electrode layer is observed with the use of SEM-EDX and/or WDX. It is possible to measure the volume ratio of the negative electrode active material by determining that a site where V is detected from EDX and/or WDX is the negative electrode active material and calculating the area ratio of the site.

The particle shape of the negative electrode active material in the negative electrode layer is not particularly limited, and may be, for example, any of a spherical shape, a flattened shape, and an indefinite shape.

The negative electrode layer may further contain a solid electrolyte in addition to the negative electrode active material. The solid electrolyte contained in the negative electrode layer is not particularly limited, and examples thereof include a solid electrolyte having a garnet-type crystal structure, a solid electrolyte having a LISICON-type crystal structure, a solid electrolyte having a perovskite-type crystal structure, a solid electrolyte having an amorphous structure, and an oxide glass ceramic-based lithium ion conductor (for example, a phosphate compound (LATP) containing lithium, aluminum, and titanium as constituent elements, and a phosphate compound (LAGP) containing lithium, aluminum, and germanium as constituent elements). At least one (particularly at least the negative electrode layer, preferably both the negative electrode layer and the solid electrolyte layer) of the negative electrode layer and the solid electrolyte layer described later preferably contains a solid electrolyte having the garnet-type crystal structure. This is because when at least one of the negative electrode layer and the solid electrolyte layer (particularly at least the negative electrode layer, preferably both the negative electrode layer and the solid electrolyte layer) contains the solid electrolyte having the garnet-type crystal structure, not only excellent capacity retention rate characteristic can be obtained, but also excellent interface resistance characteristic between the negative electrode active material and the solid electrolyte having the garnet-type crystal structure can be obtained. The fact that at least one of the negative electrode layer and the solid electrolyte layer includes the solid electrolyte that has a garnet-type crystal structure means that one of the negative electrode layer and the solid electrolyte layer may include the solid electrolyte that has a garnet-type crystal structure, or that the both may include the solid electrolyte that has a garnet-type crystal structure. When the negative electrode layer and the solid electrolyte layer both include the solid electrolyte that has the garnet-type crystal structure, the solid electrolyte that has the garnet-type crystal structure, included in the negative electrode layer, and the solid electrolyte that has the garnet-type crystal structure, included in the solid electrolyte layer, may have the same chemical composition or different chemical compositions from each other. From the viewpoint of further improving the capacity retention rate characteristic and the interface resistance characteristic, it is preferable that both the negative electrode layer and the solid electrolyte layer contain the solid electrolyte having the garnet-type crystal structure.

The solid electrolyte having the garnet-type crystal structure means, in an encompassing manner, that the solid electrolyte not only simply has a “garnet-type crystal structure”, but also has a “garnet-type similar crystal structure”. Specifically, the solid electrolyte has a crystal structure that can be identified as a garnet-type or a garnet-type similar crystal structure by those skilled in the field of solid-state batteries in X-ray diffraction. More specifically, the solid electrolyte may show, in X-ray diffraction, one or more main peaks corresponding to a Miller index unique to a so-called garnet-type crystal structure (diffraction pattern: ICDD Card No. 01-080-6142) at a predetermined incident angle, or as a pseudo-garnet-type crystal structure, one or more main peaks corresponding to a Miller index unique to a so-called garnet-type crystal structure may show one or more main peaks having different incident angles (that is, peak positions or diffraction angles) and intensity ratios (that is, peak intensities or diffraction intensity ratios) due to a difference in composition. Examples of a typical diffraction pattern of the pseudo-garnet-type crystal structure include ICDD Card No. 00 045-0109.

The solid electrolyte having the garnet-type crystal structure preferably has average chemical composition represented by, for example, the general formula (2):

$$( {Li}_{[ 7 - ax - ( b - 4 ) y ]} {A}_{x} ) {La}_{3} {Zr}_{2 - y} {Z}_{y} {O}_{12} . \qquad ( 2 )$$

Since the negative electrode layer includes the solid electrolyte that has the average chemical composition as described above, the capacity retention rate characteristic and the interface resistance characteristic can be further improved.

In the formula (2), A is one or more elements selected from the group consisting of gallium (Ga), aluminum (Al), magnesium (Mg), zinc (Zn), and scandium (Sc),

Z is one or more elements selected from the group consisting of niobium (Nb), tantalum (Ta), tungsten (W), tellurium (Te), molybdenum (Mo), and bismuth (Bi),

x has a relationship of 0≤x≤0.5,

y has a relationship of 0≤y≤2.0,

a is the average valence of A, and is the same as the average valence of A in the formula (1), and

b is the average valence of Z, and is the same as the average valence of Z in the formula (1).

In the formula (2), from the viewpoint of further improving the capacity retention rate characteristic and the interface resistance characteristic, preferred embodiments are presented as follows:

A is one or more elements selected from the group consisting of Ga and Al;

Z is one or more elements selected from the group consisting of Nb, Ta, W, Mo, and Bi;

x has a relationship of 0.1≤x≤0.3. When A contains two or more kinds of elements, x is a number based on the total number of x for each element.

y has a relationship of 0≤y≤1.0, preferably a relationship of 0≤y≤0.7. When Z contains two or more kinds of elements, y is a number based on the total number of y for each element.

a is an average valence of A.

b is an average valence of Z.

Specific examples of the solid electrolyte represented by the general formula (2) include (Li_{6.4}Ga_{0.05}Al_{0.15}) La₃Zr₂O₁₂, (Li_{6.4}Ga_{0.2}) La₃Zr₂O₁₂, Li_{6.4}La₃ (Zr_{1.6}Ta_{0.4})O₁₂, (Li_{6.4}Al_{0.2}) La₃Zr₂O₁₂, and Li_{6.5}La₃ (Zr_{1.5}Mo_{0.25})O₁₂.

The average chemical composition of the solid electrolyte (in particular, the solid electrolyte that has a garnet-type crystal structure) in the negative electrode layer means the average value for the chemical composition of the solid electrolyte in the thickness direction of the negative electrode layer. The average chemical composition of the solid electrolyte can be analyzed and measured by breaking the solid-state battery and performing composition analysis by energy-dispersive X-ray spectroscopy (EDX) using SEM-EDX in a field of view in which the entire negative electrode layer fits in the thickness direction.

In the negative electrode layer, the average chemical composition of the negative electrode active material and the average chemical composition of the solid electrolyte can be automatically distinguished and then measured depending on the compositions thereof in the composition analysis mentioned above.

The solid electrolyte of the negative electrode layer may be obtained by the same method as in the case of the negative electrode active material except that a raw material compound containing a predetermined metal atom is used, or may be obtained as a commercially available product.

The volume ratio of the solid electrolyte (particularly, the solid electrolyte having the garnet-type crystal structure) in the negative electrode layer is not particularly limited, and is preferably 10% to 50% and more preferably 20% to 40% from the viewpoint of further improving the capacity retention rate characteristic and the interface resistance characteristic.

The volume percentage of the solid electrolyte in the negative electrode layer can be measured in the same manner as the volume percentage of the negative electrode active material. The garnet-type solid electrolyte is based on a site where Zr and/or La is detected by EDX and/or WDX.

The negative electrode layer may further contain, for example, a sintering aid and a conductive material in addition to the negative electrode active material and the solid electrolyte.

For the sintering aid, sintering aids known in the field of the solid-state battery can be used. From the viewpoint of further improving the capacity retention rate characteristic and the interface resistance characteristic, the inventors have conducted studies to find as a result that the composition of the sintering additive preferably contains at least Li (lithium), B (boron), and O (oxygen), and the molar ratio of Li to B (Li/B) is preferably 2.0 or more. These sintering aids have low-melting properties, and promoting liquid-phase sintering allows the negative electrode layer to be densified at a lower temperature. Examples of the sintering aids include Li₃BO₃, (Li_{2.7}Al_{0.3}) BO₃, and Li_{2.8} (B_{0.8}C_{0.2})O₃. Among them, it is particularly preferable to use (Li_{2.7}Al_{0.3}) BO₃ having a particularly high ionic conductivity.

The volume ratio of the sintering aid in the negative electrode layer is not particularly limited, and is preferably 0.1% to 10% and more preferably 1% to 7% from the viewpoint of improving the performance of the battery characteristics. The battery characteristics mean characteristics of batteries required in a field where battery use or storage is assumed, and are, for example, the capacity retention rate characteristic, the interface resistance characteristic, and the like.

The volume percentage of the sintering aid in the negative electrode layer can be measured in the same manner as the volume percentage of the negative electrode active material. As a detection element in EDX and/or WDX to determine a region of the sintering aid, B may be focused.

Conductive materials known in the field of solid-state batteries can be used for the conductive material in the negative electrode layer. From the viewpoint of improving the performance of the battery characteristics, examples of preferably used conductive materials include metal materials such as Ag (silver), Au (gold), Pd (palladium), Pt (platinum), Cu (copper), Sn (tin), and Ni (nickel); and carbon materials such as acetylene black, Ketjen black, and carbon nanotubes such as Super P (registered trademark) and VGCF (registered trademark). The shape of the carbon material is not particularly limited, and any shape such as a spherical shape, a plate shape, and a fibrous shape may be used. As the conductive material, a metal material (particularly Ag) is preferably used from the viewpoint of improving the performance of the battery characteristics.

The volume ratio of the conductive material in the negative electrode layer is not particularly limited, and is preferably 10% to 50% and more preferably 20% to 40% from the viewpoint of improving the performance of the battery characteristics.

The volume ratio of the conductive material in the negative electrode layer can be measured by the same method as the volume ratio of the negative electrode active material. From the SEM-EDX, WDX analysis, a portion where only the signal of the used metal element is observed can be regarded as a conductive material.

In the negative electrode layer, the porosity is not particularly limited, and is preferably 20% or less, more preferably 15% or less, and still more preferably 10% or less from the viewpoint of improving the performance of the battery characteristics.

For the porosity of the negative electrode layer, a value measured from an SEM image after FIB sectional processing is used.

The negative electrode layer is a layer that may be referred to as a “negative electrode active material layer”. The negative electrode layer may have a so-called negative electrode current collector or a negative electrode current collecting layer.

### (Positive Electrode Layer)

In the present disclosure, the positive electrode layer is not particularly limited. For example, the positive electrode layer contains a positive electrode active material. The positive electrode layer preferably has the form of a fired body including positive electrode active material particles.

The positive electrode active material is not particularly limited, and a positive electrode active material known in the field of solid-state batteries may be used. Examples of the positive electrode active material include lithium-containing phosphate compound particles that have a NASICON-type structure, lithium-containing phosphate compound particles that have an olivine-type structure, lithium-containing layered oxide particles, lithium-containing oxide particles that have a spinel-type structure. Specific examples of the preferably used lithium-containing phosphate compounds that have a NASICON-type structure include Li₃V₂(PO₄)₃. Specific examples of the preferably used lithium-containing phosphate compounds that have an olivine-type structure include Li₃Fe₂(PO₄)₃ and LiMnPO₄. Specific examples of the preferably used lithium-containing layered oxide particles include LiCoO₂ and LiCo_{1/3}Ni_{1/3}Mn_{1/3}O₂. Specific examples of the preferably used lithium-containing oxides that have a spinel-type structure include LiMn₂O₄, LiNi_{0.5}Mn_{1.5}O₄, and Li₄Ti₅O₁₂. From the viewpoint of reactivity at the time of co-firing with the LISICON-type solid electrolyte used in the present disclosure, lithium-containing layered oxides such as LiCoO₂ and LiCo_{1/3}Ni_{1/3}Mn_{1/3}O₂ are more preferably used as the positive electrode active material. It is to be noted that only one of these positive electrode active material particles may be used, or two or more thereof may be used in mixture.

The positive electrode active material having a NASICON-type structure in the positive electrode layer means that the positive electrode active material (in particular, its particles have a NASICON-type crystal structure, and in a broad sense, it means that the positive electrode active material has a crystal structure that may be recognized as a NASICON-type crystal structure by a person skilled in the art of solid-state state batteries. In a narrow sense, the fact that the positive electrode active material has a NASICON-type structure in the positive electrode layer means that the positive electrode active material (in particular, particles thereof) exhibits, at a predetermined incident angle, one or more main peaks corresponding to Miller indices that are unique to a so-called NASICON-type crystal structure in X-ray diffraction. Examples of the positive electrode active material having a NASICON-type structure that is preferably used include the compounds exemplified above.

The positive electrode active material having an olivine-type structure in the positive electrode layer means that the positive electrode active material (in particular, its particles) has an olivine-type crystal structure, and in a broad sense, it means that the positive electrode active material has a crystal structure that may be recognized as an olivine-type crystal structure by a person skilled in the art of solid-state batteries. In a narrow sense, the fact that the positive electrode active material has an olivine-type structure in the positive electrode layer means that the positive electrode active material (in particular, particles thereof) exhibits, at a predetermined incident angle, one or more main peaks corresponding to Miller indices that are unique to a so-called olivine-type crystal structure in X-ray diffraction. Examples of the positive electrode active material having an olivine-type structure that is preferably used include the compounds exemplified above.

The positive electrode active material having a spinel-type structure in the positive electrode layer means that the positive electrode active material (in particular, its particles) has a spinel-type crystal structure, and in a broad sense, it means that the positive electrode active material has a crystal structure that may be recognized as a spinel-type crystal structure by those skilled in the art of solid-state batteries. In a narrow sense, the fact that the positive electrode active material has a spinel-type structure in the positive electrode layer means that the positive electrode active material (in particular, particles thereof) exhibits, at a predetermined incident angle, one or more main peaks corresponding to Miller indices that are unique to a so-called spinel-type crystal structure in X-ray diffraction. Examples of the positive electrode active material having a spinel-type structure that is preferably used include the compounds exemplified above.

The chemical composition of the positive electrode active material may be average chemical composition. The average chemical composition of the positive electrode active material means an average value of the chemical compositions of the positive electrode active material in the thickness direction of the positive electrode layer. The average chemical composition of the positive electrode active material may be analyzed and measured by breaking the solid-state battery and performing composition analysis by EDX using SEM-EDX (energy dispersive X-ray spectroscopy) in a field of view in which the whole positive electrode layer fits in the thickness direction.

The positive electrode active material can be obtained in the same manner as the negative electrode active material except that a raw material compound containing a predetermined metal atom is used, or is also available as a commercially available product.

The average particle diameter of the positive electrode active material is not particularly limited, may be, for example, 0.01 μm to 10 μm, and is preferably 0.05 μm to 4 μm.

The average particle diameter of the positive electrode active material can be determined in the same manner as the average particle diameter of the negative electrode active material in the negative electrode layer.

The volume ratio of the positive electrode active material in the positive electrode layer is not particularly limited, and is preferably 30% to 90% and more preferably 40% to 70% from the viewpoint of improving the performance of the battery characteristics.

The positive electrode layer may further contain, for example, a solid electrolyte, a sintering aid, a conductive material, and the like in addition to the positive electrode active material.

The type of solid electrolyte included in the positive electrode layer is not particularly limited. Examples of the solid electrolyte contained in the positive electrode layer include a solid electrolyte having the garnet-type crystal structure (for example, the solid electrolyte represented by the general formula (2), particularly, (Li_{6.4}Ga_{0.2}) La₃Zr₂O₁₂, Li_{6.4}La₃ (Zr_{1.6}Ta_{0.4})O₁₂, (Li_{6.4}Al_{0.2}) La₃Zr₂O₁₂, and Li_{6.5}La₃ (Zr_{1.5}Mo_{0.25})O₁₂), a solid electrolyte having a LISICON-type structure (for example, Li₃₊ₓ (V₁₋ₓSiₓ)O₄), a solid electrolyte having a perovskite-type crystal structure (for example, La_{2/3-x}Li₃ₓTiO₃), and a solid electrolyte having an amorphous structure (for example, Li₃BO₃-Li₄SiO₄). Among them, from the viewpoint of improving the performance of the battery characteristics, it is particularly preferable to use the solid electrolyte having the garnet-type crystal structure.

The solid electrolyte of the positive electrode layer may be obtained by the same method as in the case of the negative electrode active material except that a raw material compound containing a predetermined metal atom is used, or may be obtained as a commercially available product.

The volume ratio of the solid electrolyte in the positive electrode layer is not particularly limited, and is preferably 20% to 60% and more preferably 30% to 45% from the viewpoint of improving the performance of the battery characteristics.

As the sintering aid in the positive electrode layer, the same compound as the sintering aid in the negative electrode layer can be used.

The volume ratio of the sintering aid in the positive electrode layer is not particularly limited, and is preferably 0.1% to 20% and more preferably 1% to 10% from the viewpoint of improving the performance of the battery characteristics.

As the conductive material in the positive electrode layer, the same compound as the conductive material in the negative electrode layer can be used.

The volume ratio of the conductive material in the positive electrode layer is not particularly limited, and is preferably 10% to 50% and more preferably 20% to 40% from the viewpoint of improving the performance of the battery characteristics.

In the positive electrode layer, the porosity is not particularly limited, and is preferably 20% or less, more preferably 15% or less, and still more preferably 10% or less from the viewpoint of improving the performance of the battery characteristics.

For the porosity of the positive electrode layer, a value measured in the same manner as for the porosity of the negative electrode layer is used.

The positive electrode layer is a layer that may be referred to as a “positive electrode active material layer”. The positive electrode layer may have a so-called positive electrode current collector or a positive electrode current collecting layer.

### (Solid Electrolyte Layer)

The solid electrolyte layer includes a solid electrolyte. The solid electrolyte contained in the solid electrolyte layer is not particularly limited, and examples thereof include a solid electrolyte having a garnet-type crystal structure, a solid electrolyte having a LISICON-type structure (for example, Li₃₊ₓ (V₁₋ₓSiₓ)O₄), a solid electrolyte having a perovskite-type structure (for example, La_{2/3-x}Li₃ₓTiO₃), and a solid electrolyte having an amorphous structure (for example, Li₃BO₃-Li₄SiO₄). Among them, from the viewpoint of improving the performance of the battery characteristics, it is particularly preferable to use the solid electrolyte having the garnet-type crystal structure.

The garnet-type solid electrolyte contained in the solid electrolyte layer is the same as the solid electrolyte having a garnet-type crystal structure that is contained in the negative electrode layer and may be selected from the same range as the solid electrolyte having a garnet-type crystal structure described in the description of the negative electrode layer. When the solid electrolyte layer and the negative electrode layer both include a solid electrolyte that has a garnet-type crystal structure, the solid electrolyte that has a garnet-type structure, included in the solid electrolyte layer, and the solid electrolyte that has a garnet-type crystal structure, included in the negative electrode layer, may have the same chemical composition or different chemical compositions from each other.

The garnet-type solid electrolyte contained in the solid electrolyte layer is not particularly limited as long as it has a garnet-type crystal structure, and for example, similarly to the garnet-type solid electrolyte contained in the negative electrode layer, it is preferable that the garnet-type solid electrolyte has chemical composition within the range of the chemical composition represented by the general formula (2) described above. When the solid electrolyte layer contains the solid electrolyte having the chemical composition, an improvement in interface resistance characteristics can be achieved between the solid electrolyte and the negative electrode active material.

In the solid electrolyte layer, the chemical composition of the solid electrolyte may be average chemical composition. The average chemical composition of the solid electrolyte (in particular, the solid electrolyte that has a garnet-type crystal structure) in the solid electrolyte layer means the average value for the chemical composition of the solid electrolyte in the thickness direction of the solid electrolyte layer. The average chemical composition of the solid electrolyte may be analyzed and measured by breaking the solid-state battery and performing composition analysis by EDX using SEM-EDX (energy dispersive X-ray spectroscopy) in a field of view in which the whole solid electrolyte layer fits in the thickness direction.

The chemical composition and crystal structure of the solid electrolyte in the solid electrolyte layer are typically hardly changed by firing as well. The solid electrolyte preferably has the chemical composition and the crystal structure described above in the solid-state battery after firing solid electrolyte layer together with the negative electrode layer and the positive electrode layer.

The volume ratio of the solid electrolyte in the solid electrolyte layer is not particularly limited, and is preferably 10% to 100%, more preferably 20% to 100%, and still more preferably 30% to 100%, from the viewpoint of improving the performance of the battery characteristics.

The volume percentage of the solid electrolyte in the solid electrolyte layer can be measured in the same manner as the volume percentage of the solid electrolyte in the negative electrode layer.

The solid electrolyte layer may further contain, for example, a sintering aid and the like in addition to the solid electrolyte. From the viewpoint of improving the performance of the battery characteristics, at least one of the negative electrode layer and the solid electrolyte layer, preferably the both further contain a sintering aid. The fact that at least one of the negative electrode layer and the solid electrolyte layer further contains a sintering aid means that one of the negative electrode layer or the solid electrolyte layer may further contain a sintering aid, or the both may further contain a sintering aid.

As the sintering aid in the solid electrolyte layer, the same compound as the sintering aid in the negative electrode layer can be used.

The volume ratio of the sintering aid in the solid electrolyte layer is not particularly limited, and is preferably 0.1% to 20% and more preferably 1% to 10% from the viewpoint of improving the performance of the battery characteristics.

The thickness of the solid electrolyte layer is typically 0.1 μm to 30 μm, and from the viewpoint of reducing the thickness of the solid electrolyte layer, it is more preferably 1 μm to 20 μm.

As the thickness of the solid electrolyte layer, an average value of thicknesses measured at any ten points in an SEM image is used.

In the solid electrolyte layer, the porosity is not particularly limited, and is preferably 20% or less, more preferably 15% or less, and still more preferably 10% or less from the viewpoint of improving the performance of the battery characteristics.

For the porosity of the solid electrolyte layer, a value measured in the same manner as for the porosity of the negative electrode layer is used.

The solid-state battery of the present disclosure may further include any member that can be included in a conventional solid-state battery, such as a positive electrode collector layer, a negative electrode collector layer, a protective layer, and an end surface electrode.

### [Method of Producing Solid-State Battery]

The solid-state battery can be produced, for example, by a so-called green sheet method, a printing method, or a combined method thereof.

The green sheet method will be described.

First, a positive electrode active material or a raw material to be the positive electrode active material, a solvent, a resin, and the like are appropriately mixed to prepare a paste. The paste is applied onto a sheet and dried to form a first green sheet for forming a positive electrode layer. The first green sheet may contain therein a solid electrolyte, a conductive material, a sintering aid, and/or the like.

A negative electrode active material or a raw material to be the negative electrode active material, a solvent, a resin, and the like are appropriately mixed to prepare a paste. The paste is applied onto a sheet and dried to form a second green sheet for forming a negative electrode layer. The second green sheet may contain therein a solid electrolyte, a conductive material, a sintering aid, and/or the like.

A solid electrolyte or a raw material to be the solid electrolyte, a solvent, a resin, and the like are appropriately mixed to prepare a paste. The paste is applied onto a sheet and dried to form a third green sheet for forming a solid electrolyte layer. The third green sheet may contain a sintering aid and the like.

Next, the first to third green sheets are appropriately stacked to prepare a laminate. The produced laminate may be pressed. Examples of a preferable pressing method include an isostatic pressing method.

Thereafter, the laminate is fired at, for example, 600 to 800° C.; to obtain a solid-state battery.

The printing method will be described.

The printing method is the same as the green sheet method except for the following matters.
Pastes for the respective layers are prepared so as to have blending amounts of a solvent and a resin suitable for production by the printing method.
The paste for each layer is printed and stacked to produce a laminate.

Hereinafter, the present disclosure will be described in more detail based on specific examples, but the present disclosure is not limited to the following examples at all and may be appropriately changed and implemented without changing the gist thereof.

### EXAMPLES

### [Production of Material]

In the following (1) to (3), a solid electrolyte powder, a negative electrode active material, and a sintering aid were produced.

Table 1 described later shows the average chemical composition of each material of each layer after the negative electrode layer, the solid electrolyte layer, and the like are both fired for producing a half-cell in each of Examples and Comparative Examples. However, the average chemical composition did not change before and after the firing in each of Examples and Comparative Examples. Thus, in the tables, the average chemical compositions described in these examples and comparative examples also means the average chemical compositions of the respective materials used.

### (1) Production of Solid Electrolyte LLZ Powder (Solid Electrolyte Powder of Negative Electrode Layer and Solid Electrolyte Powder of Solid Electrolyte Layer) Having Garnet-Type Crystal Structure

The solid electrolyte powders LLZ having the garnet-type crystal structure used in Examples and Comparative Examples were produced as follows. Lithium hydroxide monohydrate LiOH·H₂O, lanthanum hydroxide La(OH)₃, zirconium oxide ZrO₂, and tantalum oxide Ta₂O₅ were used for raw materials. The respective raw materials were weighed such that the chemical composition was Li_{6.4}La₃Zr_{1.6}Ta_{0.4}O₁₂, encapsulated with the addition of water in a 100 ml polyethylene pot made of polyethylene, and rotated at 150 rpm for 16 hours on a pot rack to mix the raw materials. Lithium hydroxide monohydrate LiOH·H₂O as a Li source was charged in an excess of 3 wt % with respect to the target composition in consideration of Li deficiency during firing.

The obtained slurry was evaporated and dried, and then calcined at 900° C. for 5 hours to obtain a target phase.

The calcined powder obtained was, with the addition of a mixed solvent of toluene-acetone thereto, subjected to grinding for 6 hours in a planetary ball mill.

The ground powder was dried to obtain a solid electrolyte powder. The powder was confirmed to have no compositional deviation as Li_{6.4}La₃Zr_{1.6}Ta_{0.4}O₁₂ through ICP measurement.

### (2) Production of Negative Electrode Active Material Powder

### Examples 1 to 3

Raw materials including lithium hydroxide monohydrate (LiOH·H₂O), vanadium pentoxide (V₂O₅), and silicon oxide SiO₂ were weighed so as to have the chemical composition of Examples 1 to 3, and were well mixed in a mortar. Next, ethanol was added, the resulting mixture was sealed in a 100 ml polyethylene polypot, and the polypot was rotated on a pot rack at 150 rpm for 16 hours to mix the raw materials. The resulting slurry was dried, and then fired at 900° C. for 5 hours in the air. Next, the resultant fired product to which a mixed solvent of toluene and acetone was added was pulverized for 6 hours with a planetary ball mill and then dried to obtain a negative electrode active material powder in Table 1.

### Examples 4 to 6

A negative electrode active material powder was prepared in the same manner as in Examples 1 to 3 except that lithium hydroxide monohydrate LiOH·H₂O, vanadium pentoxide V₂O₅, and germanium oxide GeO₂ were used as raw materials, and weighed so as to have the chemical composition of the negative electrode active material shown in Examples 4 to 6.

### Examples 7 to 9

A negative electrode active material powder was prepared in the same manner as in Examples 1 to 3 except that lithium hydroxide monohydrate LiOH·H₂O, vanadium pentoxide V₂O₅, and titanium oxide TiO₂ were used as raw materials, and weighed so as to have the chemical composition of the negative electrode active material shown in Examples 7 to 9.

### Example 10

A negative electrode active material powder was prepared in the same manner as in Examples 1 to 3 except that lithium hydroxide monohydrate LiOH·H₂O, vanadium pentoxide V₂O₅, and silicon oxide SiO₂, and lithium phosphate Li₃PO₄ were used as raw materials, and weighed so as to have the chemical composition of the negative electrode active material shown in Examples 7 to 9.

### Comparative Example 1

A negative electrode active material powder was produced in the same manner as in Examples 1 to 3 except that lithium hydroxide monohydrate LiOH·H₂O and vanadium pentoxide V₂O₅ were used as the raw materials.

### Comparative Example 2

A negative electrode active material powder was produced in the same manner as in Examples 1 to 3 except that raw materials were weighed so as to have the chemical composition of Comparative Example 2.

### (3) Production of Sintering Additive Powder

Sintering aid powders for use in examples and comparative examples were produced as follows.

A lithium hydroxide monohydrate LiOH·H₂O, a boron oxide B₂O₃, and a lithium carbonate Li₂CO₃ were used for raw materials.

The respective raw materials were appropriately weighed such that the chemical composition was a predetermined chemical composition Li₃BO₃, well mixed in a mortar, and then subjected to calcination at 650° C.; for 5 hours.

Thereafter, the calcined powder was again well ground and mixed in a mortar, and then subjected to firing at 680° C. for 40 hours.

The fired powder obtained was, with the addition of a mixed solvent of toluene-acetone thereto, subjected to grinding for 6 hours in a planetary ball mill, and dried to obtain a sintering aid powder. The powder was confirmed to have no compositional deviation through ICP measurement.

### (Production of Half-Cell)

A half-cell was produced as follows.

The powder of the solid electrolyte having the garnet-type crystal structure, a butyral resin, and an alcohol were mixed at a mass ratio of 200:15:140, and then the alcohol was removed on a hot plate at 80° C. to give a solid electrolyte powder coated with the butyral resin serving as a binder. Next, the solid electrolyte powder coated with the butyral resin was pressed at 90 MPa and formed into a tablet using a tableting machine. The resultant solid electrolyte tablet was adequately coated with a mother powder, fired under an oxygen atmosphere at a temperature of 500° C. to remove the butyral resin, and then fired under an oxygen atmosphere at about 1200° C. for 3 hours. Thereafter, the temperature was lowered to give a solid electrolyte sintered body. A surface of the resultant sintered body was polished to give a garnet-type solid electrolyte substrate (solid electrolyte layer).

The solid electrolyte powder LLZ having the garnet-type crystal structure, a negative electrode active material powder having the chemical composition shown in Table 1, a sintering aid powder, and a conductive material powder (Ag particles) were weighed so as to have a volume ratio of 35:30:5:30, and kneaded with alcohol and a binder to prepare a negative electrode layer paste. Next, the negative electrode layer paste was applied onto the solid electrolyte layer (that is, the solid electrolyte substrate) and dried to obtain a laminate. The laminate was heated to 400° C. to remove the binder, and then heat-treated and fired at 800° C. for 2 hours in the air atmosphere to prepare a laminate of a solid electrolyte layer and a negative electrode layer. Thereafter, metal lithium as a counter electrode and a reference electrode was attached onto a surface of the solid electrolyte layer of the laminate opposite to the negative electrode layer-side surface, and warm isostatic pressing was performed at 60° C. and a pressure of 200 MPa to form a Li/solid electrolyte interface. This was sealed with a 2032-type coin cell to produce a half-cell. In order to evaluate the interface resistance value between Li and the solid electrolyte, Li was attached to both surfaces of a solid electrolyte substrate, and warm isostatic pressing was performed at 60° C. and a pressure of 200 MPa to prepare a Li/LLZ/Li cell.

### [Measurement]

### (Average Chemical Composition)

The chemical formula in Table 1 shows the average chemical composition of the negative electrode active material. The average chemical composition was measured by the following method. The average chemical composition was obtained by breaking a half-cell, polishing a cross section by ion milling, then quantitatively analyzing 10 negative electrode active material sites in the negative electrode layer by point analysis of WDX using SEM-WDX (energy dispersive X-ray spectroscopy), and then averaging the results. By performing quantitative analysis (composition analysis) by WDX in a field of view in which the entire thickness direction of each layer fits, the average chemical composition of the negative electrode active material and the solid electrolyte in the negative electrode layer and the average chemical composition of the solid electrolyte LLZ having the garnet-type crystal structure in the solid electrolyte layer were obtained.

In the present disclosure, composition analysis by JXA-8530F manufactured by JEOL Ltd. was used. Since it is difficult to quantify Li and O for the negative electrode active material, the calculation was performed using the above chemical formula with the oxygen deficiency amount δ=0 from information on A and Z prepared before firing of the chemical formula (Li_{[3-ax+(5-b)y]}Aₓ) (V_{1-y}Z)O_{4-δ} and information on x and y obtained by the composition analysis of WDX. Also for the solid electrolyte layer, the average chemical composition was obtained by quantitatively analyzing 10 solid electrolyte sites in the negative electrode layer and the solid electrolyte layer by point analysis of WDX, and then averaging the results. Since it is difficult to quantify Li and oxygen similarly to the negative electrode active material, the calculation was performed using the above chemical formula from information on A and Z prepared before firing of the chemical formula (Li_{[7-ax-(b-4)y]}Aₓ)La₃Zr_{2-y}Z_{y}O₁₂ and information on x and y obtained by the composition analysis of WDX.

In Examples 1 to 10 and Comparative Examples 1 to 2, it was confirmed that the average chemical compositions of the negative electrode active material and the solid electrolyte of the negative electrode layer and the solid electrolyte of the solid electrolyte layer after firing for manufacturing the half-cell were equivalent to the respective compositions before the firing (preparation).

### (Garnet-Type Crystal Structure)

The garnet-type crystal structure was confirmed by obtaining an X-ray diffraction image attributable to a garnet-type similar crystal structure by X-ray diffraction (XRD measurement) (ICDD Card No. 00-045-0109). Also for the negative electrode active material in the negative electrode layer, the crystal structure was confirmed by performing XRD measurement of the negative electrode layer of the half-cell. X-ray diffraction images that can be assigned to a β-LVO-structure for Comparative Example 1 and Examples 1 to 10, and a γ-LVO-structure for Comparative Example 2 were obtained, thereby confirming the crystal structure.

### (Evaluation of Solid-State Battery)

The half-cell of each Example and Comparative Example was evaluated for the following items.

### [Evaluation Method 1: Evaluation of Capacity Retention Rate Characteristic]

The solid-state batteries prepared in comparative examples and examples were evaluated at 25° C. according to the following contents.

Charging and discharging were performed using constant current charging and discharging measurement, and a charge end lower limit potential was set to 0.2 V (vs. Li/Li⁺). A discharge end upper limit potential was set to 3.0 V (vs. Li/Li⁺). The constant current value of the charging and discharging currents was 0.1 C. A theoretical value of a charge-discharge capacity was defined as an amount of electricity when a two-electron reaction proceeded with respect to V in the negative electrode active material, the current value at which the amount of electricity was charged and discharged in 10 hours was 0.1 C, and the current value at which the amount of electricity was charged and discharged in 1 hour was 1.0 C. In the present disclosure, the charge corresponds to a reduction reaction in which lithium ions are inserted into the negative electrode active material, and the discharge corresponds to an oxidation reaction in which lithium ions are desorbed from the negative electrode active material. It was confirmed that a reversible capacity of 80% or more of the theoretical value of the charge-discharge capacity was obtained in any cell used in the present disclosure.

An initial charge capacity of the prepared solid-state battery at 0.1 C and the initial charge capacity at 1.0 C were measured. The “(capacity at 1.0 C charge/capacity at 0.1 C charge)×100” was defined as a 1 C capacity retention rate.

⊙; 67%<1.0 C capacity retention rate≤100% (best);

◯; 50%<1.0 C capacity retention rate≤67% (good);

x; 1 C capacity retention rate≤50% (problem in practical use)

Comparison of Examples 1 to 10 and Comparative Example 1 with Comparative Example 2 shows that the sample having a γ-Li₃VO₄ (LVO) type crystal structure of Comparative Example 2 has a 1C capacity retention rate of 49%, which is not sufficient. On the other hand, in a sample having the substituted β_{II}-Li₃VO₄ (LVO) type crystal structure of Examples 1 to 10 and the unsubstituted β_{II}-Li₃VO₄ (LVO) type crystal structure of Comparative Example 1, the 1C capacity retention rate is improved. It is considered that a reaction mechanism of charge and discharge is different between the β_{II}-Li₃VO₄ (LVO) type crystal structure and the γ-Li₃VO₄ (LVO) type crystal structure. In the γ-Li₃VO₄ (LVO) type crystal structure, the resistance after a charge depth of 60% is very high, and particularly large diffusion resistance of Li in the negative electrode active material in this region is considered to be a cause of a low capacity retention rate (FIG. 2). From the above, it has been found that the sample having the β-Li₃VO₄ structure exhibits a high capacity retention rate under charging at a high rate, that is, high speed charging is possible, and is more preferable.

### [Evaluation Method 2: Evaluation of Interface Resistance Characteristic]

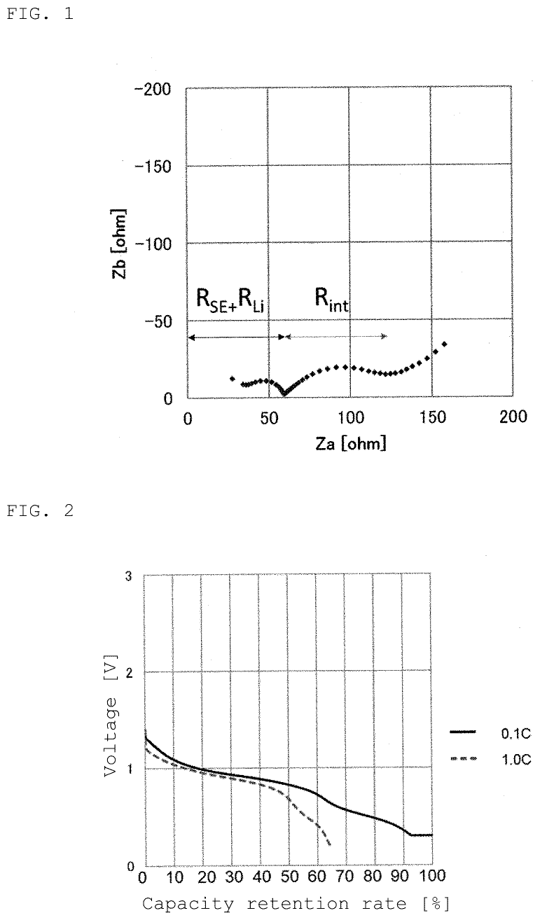

A “Li/LLZ/negative electrode active material-LLZ-Ag negative electrode” half-cell was constructed, and impedance was measured under conditions of a charge depth of 50% at the time of initial charge, 25° C., 7 MHz to 0.1 Hz, and an applied voltage of 10 mV. A relationship between an actual component (Za) and an imaginary component (Zb) of the impedance is shown in FIG. 1. In FIG. 1, a first arc R_{SE} and a second arc Rᵢₙₜ of the solid electrolyte are assigned to the interface resistance between the negative electrode active material and the solid electrolyte LLZ having the garnet-type crystal structure. The resistance was read from an intersection of the arc with a real axis. A product of an area of the negative electrode layer after firing and the resistance value was calculated as the interface resistance value. It was confirmed that the interface resistance between Li and LLZ was sufficiently smaller (<5 Ωcm²) than that of the Li/LLZ/Li cell prepared above.

⊙⊙; interface resistance≤67 Ωcm² (best);

⊙; 67 Ωcm²<interface resistance≤82 Ωcm² (excellent)

◯; 82 Ωcm²<interface resistance≤150 Ωcm² (good);

x; interface resistance>150 Ωcm² (not acceptable) (problem in practical use).

Comparison with Examples 1 to 10, Comparative Example 1, and Comparative Example 2 shows that the solid-state battery containing the negative electrode active material having the unsubstituted β_{II}-Li₃VO₄ (LVO) type crystal structure of Comparative Example 1 has a larger interface resistance with LLZ. On the other hand, in the solid-state battery containing the negative electrode active material having the substituted β_{II}-Li₃VO₄ (LVO) type crystal structure and the γ-Li₃VO₄ (LVO) type crystal structure, it is found that the value of the interface resistance with LLZ is significantly reduced, and the interface resistance characteristic is improved. As described above, since the interface resistance with LLZ is low, overvoltage can be reduced during charging and discharging. This makes it possible to reduce energy loss during charging, which is preferable.

Table 1 shows that in the solid-state battery containing the negative electrode active material having the substituted β_{II}-Li₃VO₄ (LVO) type crystal structure of Examples 1 to 10, sufficiently excellent results are obtained in both the capacity retention rate characteristic and the interface resistance characteristic.

TABLE 1

| | | | Capacity retention rate | | Interface resistance | |
|---|---|---|---|---|---|---|
| | | | characteristic | | characteristic | |
| | Chemical composition of | | Capacity | | Interface | |
| | negative electrode | Crystal | retention rate | | resistance | |
| | active material | structure | [%] | Determination | [Ωcm²] | Determination |
| Comparative | Li₃VO₄ | β structure | 72 | ⊙ | 155 | X |
| example 1 | | | | | | |
| Comparative | Li_{3.2}(V_{0.80}Si_{0.20})O₄ | γ structure | 49 | X | 66 | ⊙⊙ |
| example 2 | | | | | | |
| Example 1 | Li_{3.01}(V_{0.99}Si_{0.01})O₄ | β structure | 73 | ⊙ | 98 | ◯ |
| Example 2 | Li_{3.02}(V_{0.98}Si_{0.02})O₄ | β structure | 74 | ⊙ | 87 | ◯ |
| Example 3 | Li_{3.04}(V_{0.96}Si_{0.04})O₄ | β structure | 72 | ⊙ | 66 | ⊙⊙ |
| Example 4 | Li_{3.01}(V_{0.98}Ge_{0.02})O₄ | β structure | 72 | ⊙ | 97 | ◯ |
| Example 5 | Li_{3.02}(V_{0.95}Ge_{0.05})O₄ | β structure | 71 | ⊙ | 83 | ◯ |
| Example 6 | Li_{3.04}(V_{0.91}Ge_{0.09})O₄ | β structure | 68 | ⊙ | 70 | ⊙ |
| Example 7 | Li_{3.01}(V_{0.98}Ti_{0.02})O₄ | β structure | 75 | ⊙ | 100 | ◯ |
| Example 8 | Li_{3.02}(V_{0.96}Ti_{0.04})O₄ | β structure | 75 | ⊙ | 88 | ◯ |
| Example 9 | Li_{3.10}(V_{0.90}Ti_{0.10})O₄ | β structure | 70 | ⊙ | 81 | ⊙ |
| Example 10 | Li_{3.02}(V_{0.96}Ti_{0.02}P_{0.02})O₄ | β structure | 65 | ◯ | 68 | ⊙ |

β structure = β_{II}-Li₃VO₄ crystal structure

The solid state battery according to an embodiment of the present disclosure can be used in various fields where battery use or power storage is assumed. Although it is merely an example, the solid-state battery according to an embodiment of the present disclosure can be used in the field of electronics mounting. The solid-state battery according to an embodiment of the present disclosure can also be used in the fields of electricity, information, and communication in which mobile devices and the like are used (for example, electric and electronic equipment fields or mobile equipment fields including mobile phones, smartphones, smartwatches, notebook computers, and small electronic machines such as digital cameras, activity meters, arm computers, electronic papers, wearable devices, RFID tags, card-type electronic money, and smartwatches), home and small industrial applications (for example, the fields of electric tools, golf carts, and home, nursing, and industrial robots), large industrial applications (for example, the fields of forklift, elevator, and harbor crane), transportation system fields (for example, the fields of hybrid vehicles, electric vehicles, buses, trains, power-assisted bicycles, electric two-wheeled vehicles, and the like), power system applications (for example, fields such as various types of power generation, road conditioners, smart grids, and household power storage systems), medical applications (medical device fields such as hearing aid buds), pharmaceutical applications (fields such as dosage management systems), IoT fields, space and deep sea applications (for example, fields such as space probes and submersibles), and the like.

1. A negative electrode active material having a β-LVO-type crystal structure, wherein a part of the V element is substituted with one or more elements capable of having a tetracoordinate structure.

2. The negative electrode active material according to claim 1, wherein the one or more elements capable of having the tetracoordinate structure is one or more elements selected from Zn, Al, Ga, Si, Ge, P, and Ti.

3. The negative electrode active material according to claim 1, wherein the one or more elements capable of having the tetracoordinate structure is one element selected from Zn, Al, Ga, Si, Ge, P, and Ti.

4. The negative electrode active material according to claim 1, wherein the one or more elements capable of having the tetracoordinate structure is one or more elements selected from Si, Ge, P, and Ti.

5. The negative electrode active material according to claim 1, wherein the one or more elements capable of having the tetracoordinate structure is one element selected from Si, Ge, P, and Ti.

6. The negative electrode active material according to claim 1, wherein when Z is defined as the one or more elements capable of having the tetracoordinate structure, and r is defined as r=substance amount of the Z/(substance amount of the element V+substance amount of the Z), 0<r≤0.20.

7. The negative electrode active material according to claim 1, wherein the a β-LVO-type crystal structure is one of Li_{3.01} (V_{0.99}Si_{0.01})O₄, Li_{3.02} (V_{0.98}Si_{0.02}) O₄, Li_{3.04} (V_{0.96}Si_{0.04}) O₄, Li_{3.01} (V_{0.98}Ge_{0.02}) O₄, Li_{3.02} (V_{0.95}Ge_{0.05}) O₄, Li_{3.04} (V_{0.91}Ge_{0.09}) O₄, Li_{3.01} (V_{0.98}Ti_{0.02}) O₄, Li_{3.02} (V_{0.96}Ti_{0.04}) O₄, Li_{3.10} (V_{0.90}Ti_{0.10}) O₄, and Li_{3.02} (V_{0.96}Si_{0.02}P_{0.02}) O₄).

8. The negative electrode active material according to claim 1, wherein the negative electrode active material has average chemical composition represented by:
$$( {Li}_{[ 3 - ax + ( 5 - b ) y ]} {A}_{x} ) ( {V}_{1 - y} {Z}_{y} ) {O}_{4 - b} \qquad ( 1 )$$
wherein A is at least one element selected from Na, K, Mg, Ca, Al, Ga, Zn, Fe, Cr, and Co;
Z is the one or more elements capable of having the tetracoordinate structure;
0≤x≤1.0;
0<y≤0.20;
0≤δ≤0.5;
a is an average valence of A; and
b is an average valence of Z.

9. The negative electrode active material according to claim 8, wherein Z contains Si, and 0<y≤0.05.

10. The negative electrode active material according to claim 8, wherein Z contains Si, and 0.025≤y≤0.045.

11. The negative electrode active material according to claim 8, wherein Z contains Ge, and 0<y≤0.10.

12. The negative electrode active material according to claim 8, wherein Z contains Ge, and 0.060≤y≤0.100.

13. The negative electrode active material according to claim 8, wherein Z contains Ti, and 0<y≤0.15.

14. The negative electrode active material according to claim 8, wherein Z contains Ti, and 0.060≤y≤0.110.

15. The negative electrode active material according to claim 8, wherein Z contains P, and 0<y≤0.080.

16. The negative electrode active material according to claim 8, wherein 0≤x≤0.20.

17. The negative electrode active material according to claim 1, wherein the β-LVO-type crystal structure is a β_{II}-Li₃VO₄-type crystal structure.

18. A solid-state battery comprising:
a negative electrode layer;
a positive electrode layer; and
a solid electrolyte layer between the negative electrode layer and the positive electrode layer,
wherein the negative electrode layer contains the negative electrode active material according to claim 1.

19. The solid-state battery according to claim 18, wherein at least one of the negative electrode layer and the solid electrolyte layer contains a solid electrolyte having a garnet-type crystal structure.

20. The solid-state battery according to claim 18, wherein the negative electrode layer, the positive electrode layer, and the solid electrolyte layer are co-fired layers.
